(19) United States
(12) Patent Application Publication
(10) Pub. No.: US 2007/0229504 A1
(43) Pub. Date: Oct. 4, 2007

(54) IMAGE PROCESSING APPARATUS

(75) Inventors: Keiichi Matsunaga, Seto-shi, Aichi-ken (JP); Takahiro Ikeno, Seto-shi, Aichi-ken (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA

(21) Appl. No.: 11/690,462

(22) Filed: Mar. 23, 2007

(30) Foreign Application Priority Data
Mar. 24, 2006 (JP) 2006084256

(51) Int. Cl. G06T 11/20

(52) U.S. Cl. 345/440

(57) ABSTRACT

An image processing apparatus includes: a display device; and a processor. The processor operates to: perform a process for processing an image, the process including a plurality of process steps including an image acquiring process step for acquiring an image data and an image processing process step for processing the image data; control the display device to display a plurality of process objects, each of which representing each of the process steps, to be arranged in an order corresponding to an order in which the process steps are performed; and control the display device to display an active process object, which represents an active process step that is currently being performed, in an appearance different from that of other process objects that are currently being not performed.

### CROSS-REFERENCE TO RELATED APPLICATION

This application claims priority from Japanese Patent Application No. 2006-084256, filed on Mar. 24, 2006, the entire subject matter of which is incorporated herein by reference.

### TECHNICAL FIELD

Aspects of the present invention relate to an image processing apparatus having a display.

### BACKGROUND

Conventionally, there is proposed a guidance displaying apparatus for providing a user a guidance of operations to be easily understood. An example of such guidance displaying apparatus is disclosed in JP-A-10-021030.

The guidance displaying apparatus is provided with a storage having a guidance data area in which description data for describing various operations are stored for each of operational steps. The guidance displaying apparatus outputs a status-request command when a subsequent operation is specified after a help driver being activated. A status response generated by self-checking current operational step in response to the status-request command is received, and, based on the status response, relevant description data is read out from the guidance data area to be displayed.

In the conventional guidance displaying apparatus, although description data that describes each of the operational steps is displayed, the user may not always easily recognizes which of the displayed operational steps is currently performed.

### SUMMARY

According to an aspect of the present invention, there is provided an image processing apparatus including; a display device; and a processor. The processor operates to: perform a process for processing an image, the process including a plurality of process steps including an image acquiring process step for acquiring an image data and an image processing process step for processing the image data; control the display device to display a plurality of process objects, each of which representing each of the process steps, to be arranged in an order corresponding to an order in which the process steps are performed; and control the display device to display an active process object, which represents an active process step that is currently being performed, in an appearance different from that of other process objects that are currently being not performed.

According to another aspect of the present invention, there is provided an image processing apparatus including: a display means for displaying information; a processing means for performing a process for processing an image, the process including a plurality of process steps including an image acquiring process step for acquiring an image data and an image processing process step for processing the image data; a first controlling means for controlling the display means to display a plurality of process objects, each of which representing each of the process steps, to be arranged in an order corresponding to an order in which the process steps are performed; and a second controlling means for controlling the display means to display an active process object, which represents an active process step that is currently being performed, in an appearance different from that of other process objects that are currently being not performed.

### BRIEF DESCRIPTION OF THE DRAWINGS

In the accompanying drawings:

FIG. 1 is a plan view of an image processing apparatus according to a first example of the present invention in a state where a cover plate is opened;

FIG. 2 is a plan view showing a modified example of the image processing apparatus in which the display is disposed beside a scanner unit;

FIG. 3 is a block diagram showing a configuration of the image processing apparatus;

FIG. 4 shows a communication relationship among a plurality of processes;

FIG. 5 is a table showing display data for a copy mode;

FIG. 6 is a flowchart showing a copy mode process performed by a display control program;

FIG. 7 shows an exemplary screen displayed on the display in the copy mode;

FIG. 8 is a table showing display data for a fax transmission mode;

FIG. 9 is a flowchart showing a generalized operation mode process performed by a display control program;

FIG. 10 is an example of a screen of the display in a case where the display is provided with a touch panel device; and

FIG. 11 is an example of the screen of the display in a state where an enlarged message box is displayed.

### DESCRIPTION

An image processing apparatus according to an example of the present invention will be described below by referring to the accompanying drawings. It is to be understood that the following example is merely an example in which the present invention is embodied and, as a matter of course, the example can be appropriately modified without changing the spirit and scope of the present invention.

The image processing apparatus according to the example is configured as a multi-function device that performs a plurality of functions including a copy function, a facsimile function, a printer function, a scanner function, and a function to access a portable device that is attachable thereto.

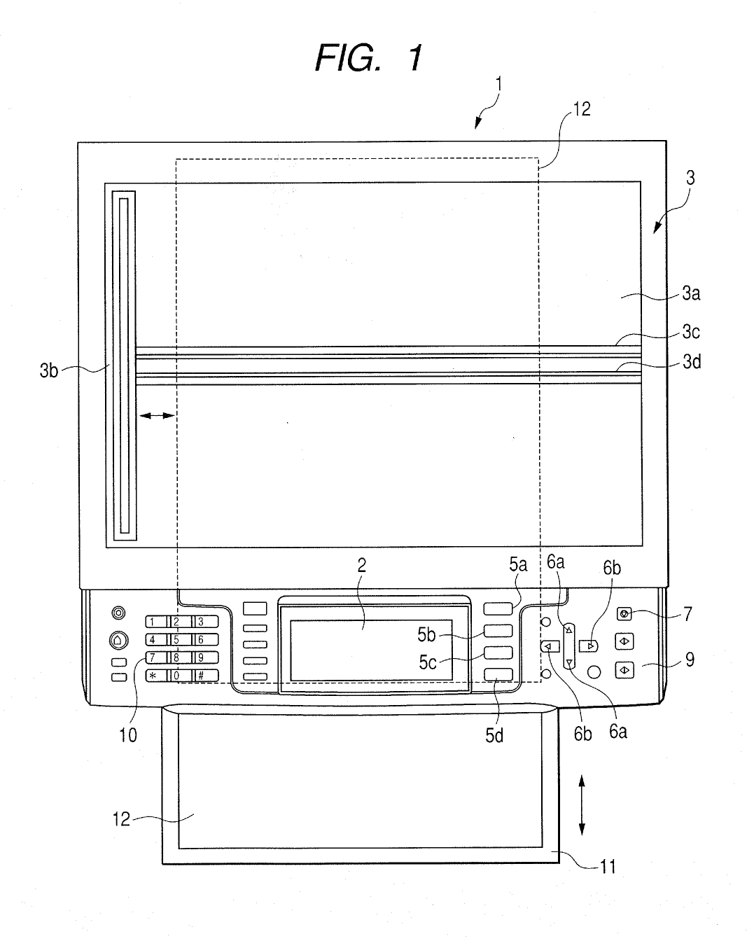

The image processing apparatus 1 is formed in a box shape having substantially square shape when viewed from top, as shown in FIG. 1. The image processing apparatus 1 is provided with an operation panel 9 on an upper surface at a position near to a front side. The image processing apparatus 1 is also provided with a scanner unit (i.e., image scanning unit) 3 and a cover plate on an upper portion.

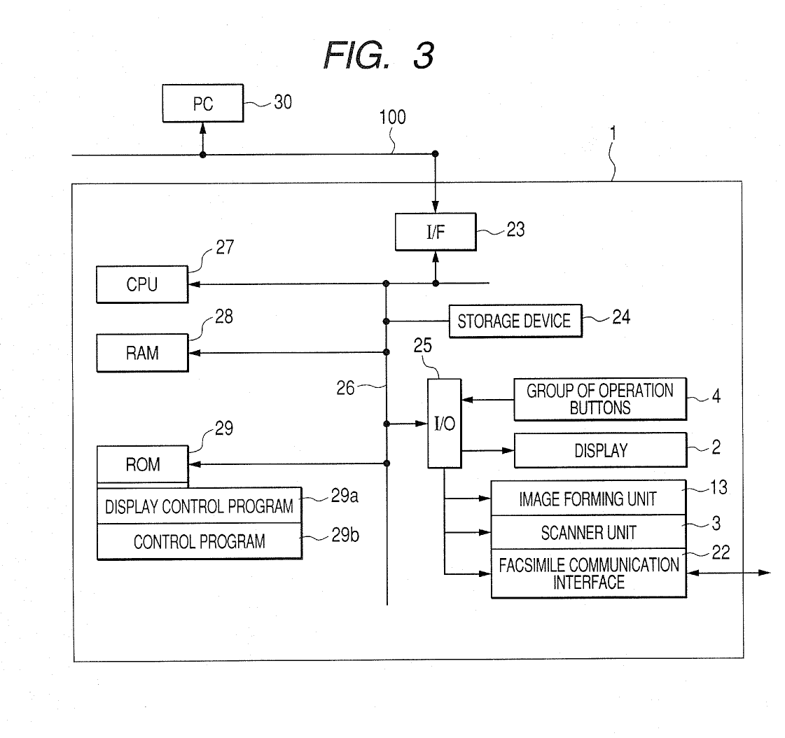

The operation panel 9 is provided with a display 2 and a group of operation buttons 4 (see FIG. 3) that includes: a button for accessing a portable device 5a; a button for selecting the copy function 5b; a button for selecting the facsimile function 5c; a button for selecting the scanner function 5d; an up-down button 6a; a left-right button 6b, a stop button 7; and numeric buttons 10.

The display 2 is disposed at a position near the center in a widthwise direction of the operation panel 9 and displays an image scanned from a sheet (document) by the scanner unit 3, and information to be notified to a user when performing the copy function, the facsimile function, the printer function, or the scanner function.

The display 2 has a screen having a size in a depth direction of the image processing apparatus being set to be substantially equal to a size obtained by subtracting a size of a platen 3a of the scanner unit 3 in the depth direction from a size of a body of the image processing apparatus 1 in the depth direction. In other words, the display 2 has a screen having relatively large in size, and hence can display images and information in a large size.

The screen of the display 2 is configured to have a rectangle shape having a width larger than a height. Accordingly, the display 2 displays a plurality of images in portrait size to be arranged next to one another.

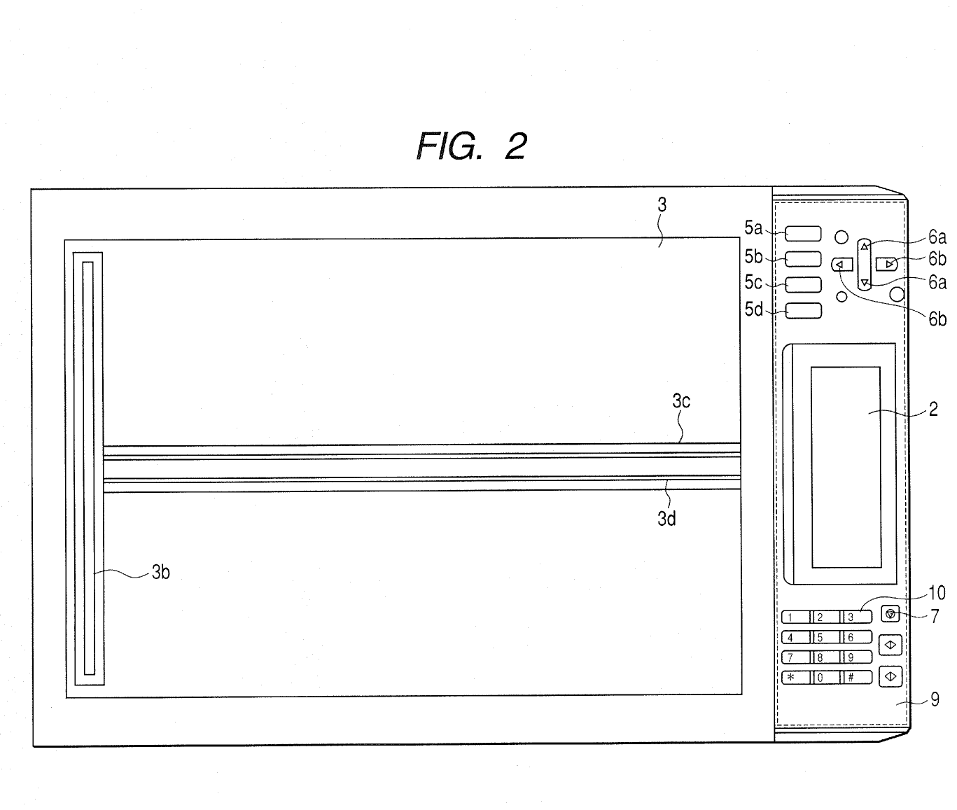

Although the display 2 of the present example is disposed to extend in the widthwise direction of the image processing apparatus 1 as shown in FIG. 1, the display 2 may be disposed to extend in the depth direction the image processing apparatus 1 as such shown in FIG. 2.

The scanner unit 3 is provided with a scanning face having a size large enough to scan, for example, an A4-size sheet (document). The scanning face of the scanner unit 3 has a rectangular shape when viewed from a top, and the scanner unit 3 is disposed so that the wider edge of the scanning face is arranged to be in parallel to the widthwise direction.

The scanner unit 3 outputs image data including the scanned image to be displayed on the screen of the display 2 as a color image, or to be printed on a recording sheet 12 in accordance with an operation input by the user through the operation buttons 4.

The recording sheets 12 are, for example, A4 in size, and are stored in a sheet tray 11 in a stacked state. As shown in FIG. 1, the sheet tray 11 can be detachably attached into the image processing apparatus 1 from the front side of the image processing apparatus 1. The recording sheets 12 are thus placed in the image processing apparatus 1, so that the longer edge of the recording sheets 12 are arranged to be parallel in the depth direction, while the longer edge of the scanner unit 3 is arranged to be parallel in the widthwise direction of the image processing apparatus 1. The image processing apparatus 1 is formed in a substantially square shape when viewed from top.

Next, referring to the block diagram of FIG. 3, a description will be given of a control circuit provided in the image processing apparatus 1. The image processing apparatus 1 includes a CPU (Central Processing Unit) 27, a RAM (Random Access Memory) 28, a ROM (Read Only Memory) 29 that stores various programs, a bus line 26 through which the components are connected together, an I/O (Input/Output) 25 connected to the bus line 26, a storage device 24 connected to the bus line 26 (which is a nonvolatile memory such as an EEPROM (Electrically Erasable & Programmable Read Only Memory) or a hard disk, or, alternatively, which may be a portable device such as a USB storage having a flash memory), and a communication interface 23 (referred to as an “I/F” in FIG. 3) that is connected to a communication network 100 and that sends and receives data to and from a personal computer (PC) 30.

Either a wired communication interface or a wireless communication interface may be used as the communication interface 23. The display 2, the scanner unit 3, the group of operation buttons 4, the image forming unit 13, and a facsimile communication interface 22 are connected to the I/O 25. The facsimile communication interface 22 is connected to a public line.

The ROM 29 stores software programs such as a display control program 29a and a control program 29b. The display control program 29a is to display a plurality of processes that serve to provide functions in the form of a series of process objects on the display 2. The control program 29b is to operate the image forming unit 13, the scanner unit 3, and the facsimile communication interface 22 through the operation of the group of operation buttons 4.

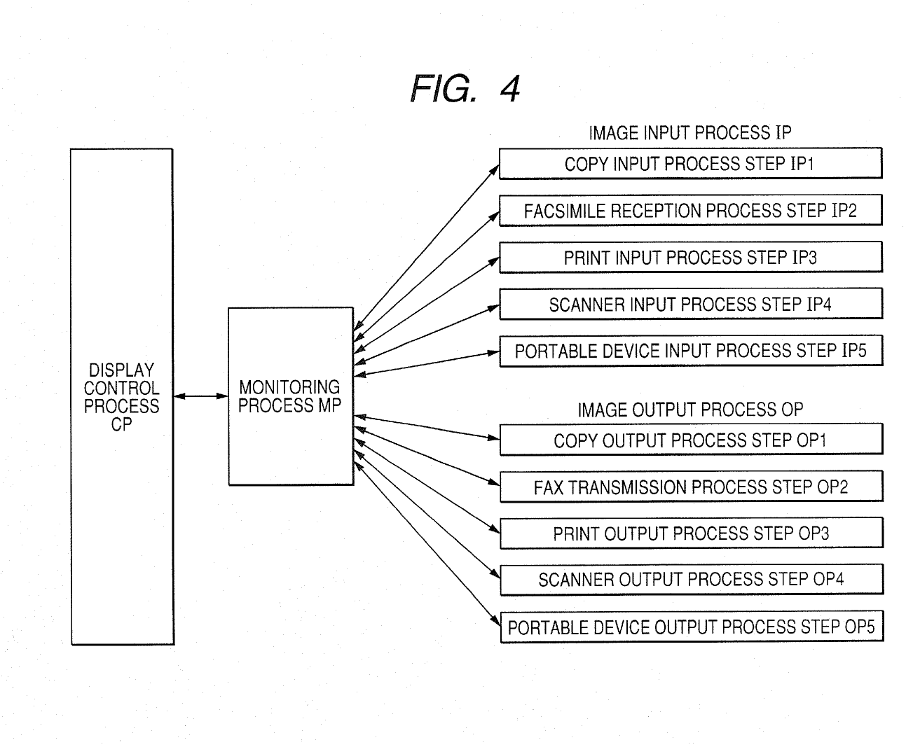

FIG. 4 shows a communication relationship among a plurality of processes including: a display control process CP by the display control program 29a; a monitoring process MP; an image input process IP that includes a copy input process step IP1, a facsimile reception process step IP2, a print input process step 1P3, a scanner input process step 1P4, and a portable device input process step 1P5; and an image output process OP that includes a copy output process step OP1, a fax transmission process step OP2, a print output process step OP3, a scanner output process step OP4, and a portable device output process step OP5.

The display control process CP and the image input process IP communicate with each other through the monitoring process MP. The display control process CP and the image output process OP communicate with each other through the monitoring process MP.

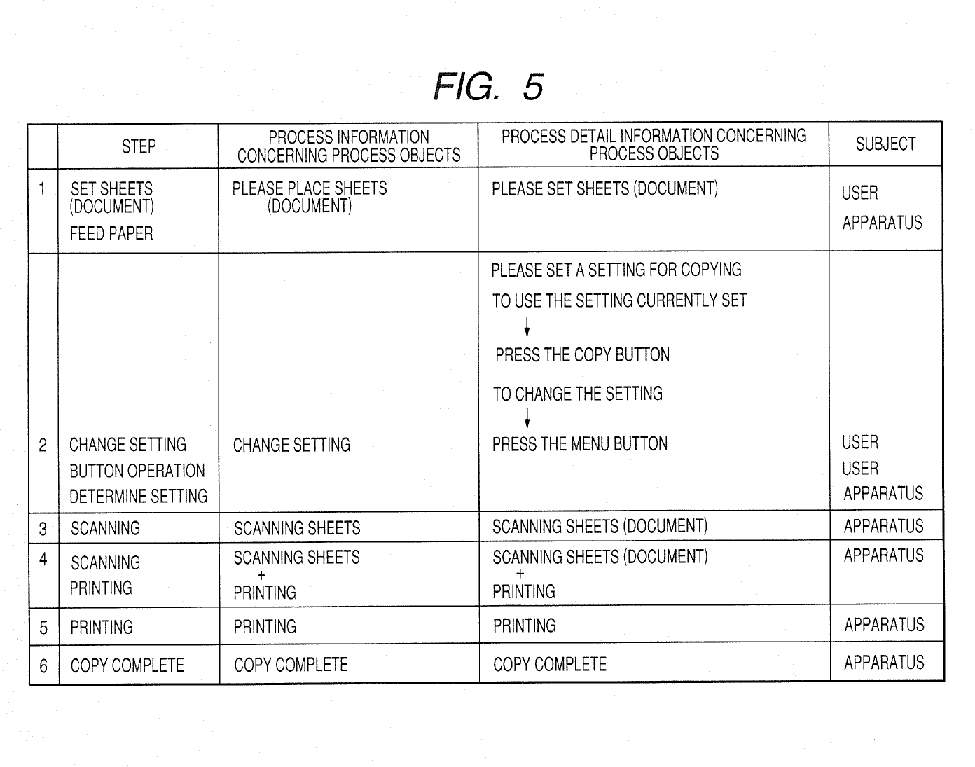

FIG. 5 is a table showing display data to be displayed in a copy mode. The display data for the copy mode has a plurality of records, each of which indicating a process, process information concerning a process object, information concerning details of the process object (hereinafter, referred to as “process detail information”), and a subject (i.e., a user or an apparatus). The records are stored in order to be performed. Note that the display data in the copy mode (and also in the other modes) are pre-stored in the storage device 24.

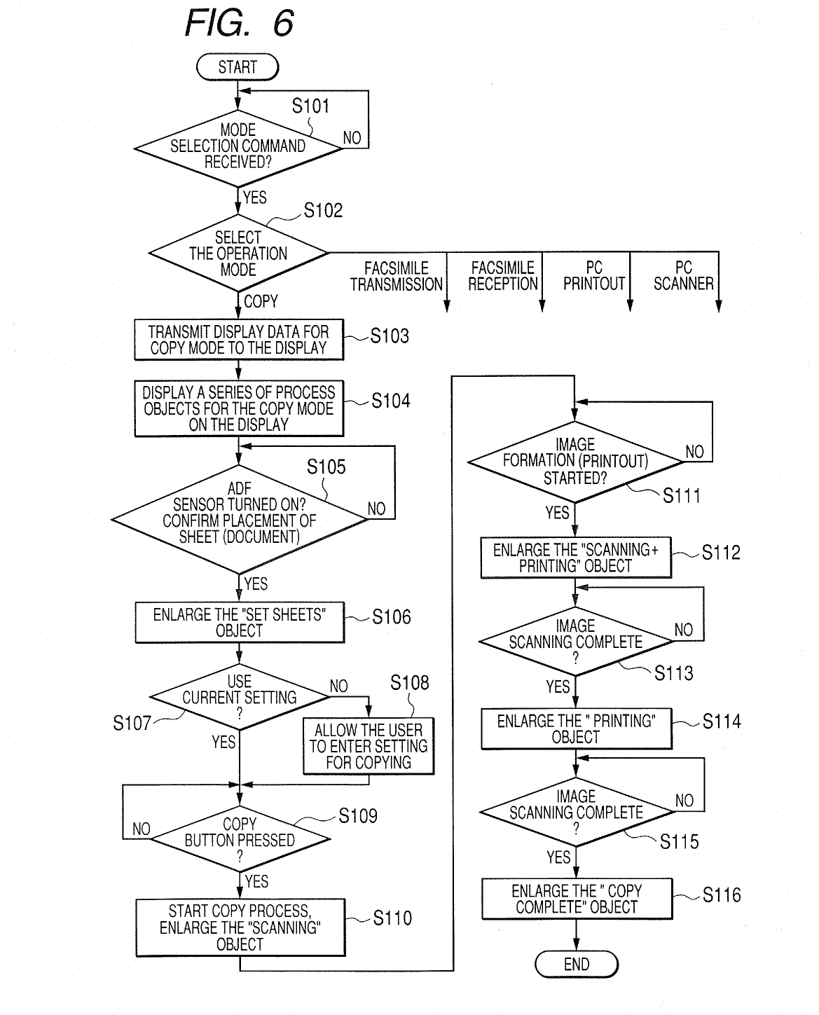

FIG. 6 is a flowchart showing a copy mode process performed by the CPU 27 in accordance with the display control program 29a.

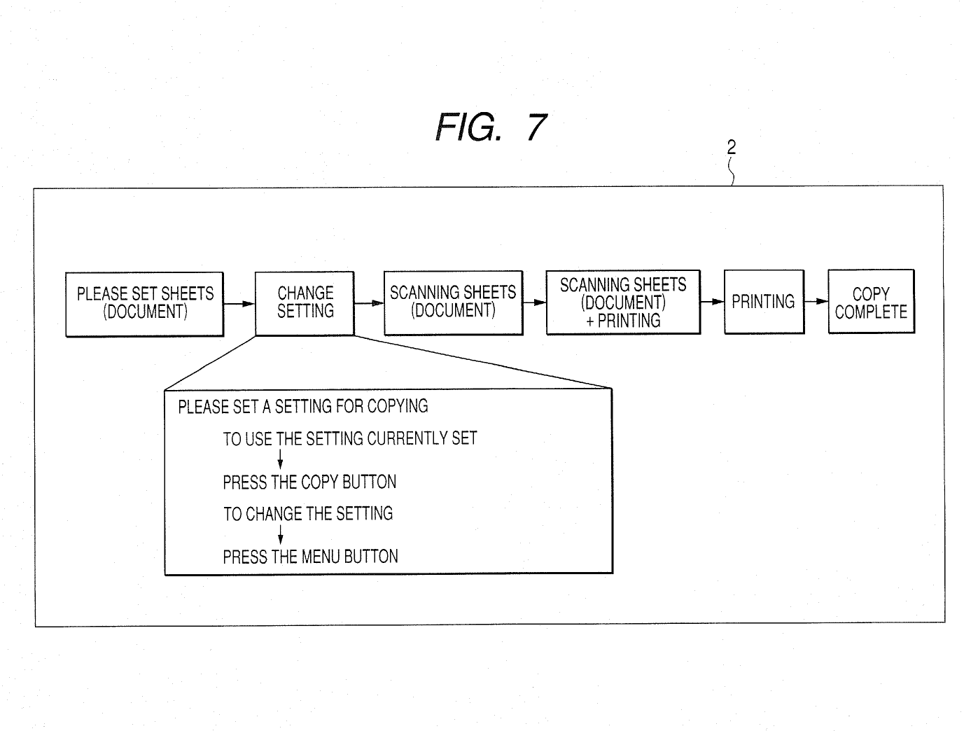

FIG. 7 shows an example of a screen displayed on the display 2 in the copy mode. Herein, a plurality of steps to be performed in sequence in the copy mode are displayed as a series of process objects. As shown in FIG. 7, the process object that is now being activated (herein after referred to as “active process object”) is displayed with an enlarged message box. The process detail information concerning the corresponding process object is displayed in the enlarged message box.

Next, referring to FIGS. 1-7, a description will be made of the operation of the thus configured image processing apparatus 1 according to the example.

When the user selects the copy mode by pressing the operation buttons 4, the CPU 27 is interrupted, so that a mode selection command that indicates the selection of the copy mode is sent to the display control process CP.

When the display control process CP receives the mode selection command (S101 of FIG. 6: YES), the copy mode corresponding to the mode selection command is selected (S102 of FIG. 6). Accordingly, the copy function is selected, the copy function including the scanner input process step IP4 of the image input process IP and the print output process step OP3 of the image output process OP.

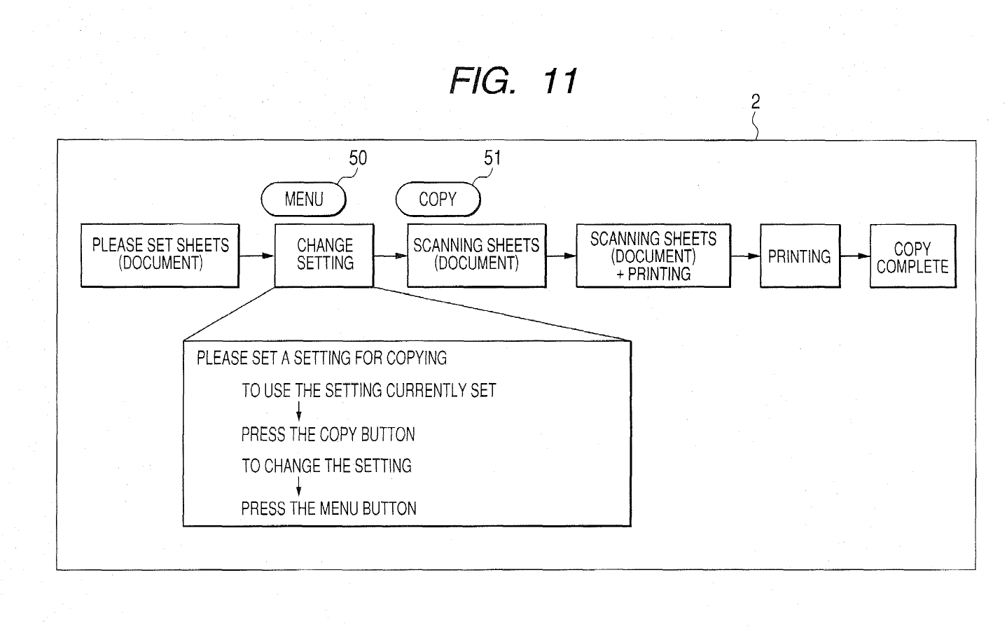

Thereafter, the display control process CP obtains display data for the copy mode, shown in FIG. 11, from the storage device 24, and transmits the display data in the copy mode to the display 2 (S103 of FIG. 6).

As a result, the display 2 displays a plurality of process objects to be performed in sequence in the copy mode in the form of a series of process objects as shown in, for example, FIG. 7 (S104 of FIG. 6). In this example, the display 2 shows, a “set sheets” object, a “change setting” object, an “scanning” object, an “scanning+printing” object, an “printing” object, and a “copy complete” object are displayed as the series of process objects.

Thereafter, the display control process CP determines whether a sheet (document) is placed on the scanner unit 3 based on whether an ADF (Auto Document Feeder) sensor, not shown, is turned on or not (S105 of FIG. 6). The placement of the sheet may be determined based on whether the scanner input process step IP4 received a notice of an ON or OFF state sent when the state of the ADF sensor is obtained, or the placement of the sheet may be determined by obtaining the ON/OFF state of the ADF sensor. In a case where the scanner unit 3 is configured as a flat-bed type, an image cannot be detected with the ADF sensor, and hence the determination is made by determining whether or not “the copy button is pressed?” (S109 of FIG. 6) in a loop in which the determination “NO” is made at step S105. If determined to be “NO” in step S105 the process loops back to step S105, and, if determined to be “YES” in step S105, the process proceeds to step S110.

Thereafter, the display control process CP enlarges the “set sheets” object (S106 of FIG. 6), and determines whether the setting being currently set is to be used or not (S107 of FIG. 6).

If determined that the setting currently set is not to be used (S107 of FIG. 6: NO), the display control process CP allows the user to change the setting for copying (S108 of FIG. 6). In more detail, the display control process CP enlarges the “change setting” object to display the enlarged message box showing process detail information to notify the user that “Please set a setting for copying. To use the setting currently set ->Press the copy button. To change the setting ->Press the menu button”. The user sees the process detail information displayed in the enlarged message box, and can select the setting for copying without entering a wrong operation.

After the user completes entering the setting for copying, or when the user selects to use the setting currently set (S107 of FIG. 6: YES), the display control process CP determines whether the copy button 5b is pressed or not (S109 of FIG. 6).

Although the present example is described based on the assumption that a determination is made by allowing the display control process CP to confirm the ON/OFF state of the copy button 5b, a “YES” determination can be made if a notice, which notifies that an image input operation is started, is obtained from the image input process IP.

If the copy button 5b is pressed (S109 of FIG. 6: YES), the display control process CP starts a copy operation (i.e., an image input operation from the scanner unit 3 by the scanner input process step IP5), and the “scanning” object is displayed to be enlarged in the display 2 (S110 of FIG. 6).

The scanner input process step IP5 allows the scanner unit 3 to scan the sheet with a line sensor 3b. The image scanned by the line sensor 3b is stored in the RAM 28 in real time. When an image scanning operation is started, the scanner input process step IP5 acquires the value of the width-size of the sheet. The value of the width-size of the sheet is determined by measuring the size of the sheet with the line sensor 3b or by allowing the user to specify the size of the sheet to be scanned. The value of the number of colors and the value of the resolution of image to be generated when scanning the sheet are obtained. The number of colors and the resolution of the image data generated depend on the number of colors and the resolution of the print output process step OP3 included in the image output process OP. Alternatively, the user may be allowed to select the values from a predetermined selection range.

When an image input operation is started, the scanner input process step IP5 sends a notice that an image input operation is started to the display control process CP through the monitoring process MP. Instead of sending such notice, a flag may be turned ON. The scanner input process step IP5 turns on an input-completion flag whenever the scanning operation completes scanning one sheet. On the other hand, the scanner input process step IP5 turns off the input-completion flag whenever a scanning operation starts scanning another sheet.

Thereafter, the display control process CP determines whether the print output process step OP3 starts an image forming operation (S111 of FIG. 6). If not (S111 of FIG. 6: NO), the display control process CP waits at step S111.

At the start-up, the print output process step OP3 acquires information determining the target image to be print out from among the images stored in the RAM 28 by the process steps included in the image input process IP. The print output process step OP3 further acquires information from the monitoring process MP that monitors an active process step of the image output process OP. Alternatively, since a start flag is turned ON when the image output process OP is started, the start flag can be ascertained.

Next, the CPU 27 acquires process-parameter information that indicates the width-size, the number of colors, and the resolution of the image being scanned by the image input process IP, which is selected as an input source of the target image. The image input process IP may acquire the information from the memory (the RAM 28 or the storage device 24) in which the information is stored, or may be acquired through an inquiry made to the image input process IP.

The CPU 27 calculates, based on the process parameter information, for example, how many bytes of data is to be stored in the RAM 28 for starting of the image output process OP. Subsequently, the print output process step OP3 sends a notice to the display control process CP through the monitoring process MP when a progress is made in the image output process OP. Instead of sending a notice, the image processing apparatus 1 may be provided with a counter that counts the progress made in the image output process OP. The print output process step OP3 sends a notice to the display control process CP through the monitoring process MP when the image formation (print out) of an image on the recording sheet is completed. Instead, the CPU 27 may be notified by the counter.

When all of the images that are scanned from the sheets is formed on the recording sheets and completed, the print output process step OP3 sends a notice that an image forming operation has been completed to the display control process CP through the monitoring process MP. Instead, a flag may be turned ON.

The monitoring process MP monitors data being stored in the RAM 28 by the scanner input process step IP4, and sends a notice of the start of an image forming operation to the display control process CP when enough data to start the image forming operation are accumulated.

When the notice of the start of the image forming operation is received (S111 of FIG. 6: YES), the display control process CP enlarges the “scanning+printing” object in the display 2 (S112 of FIG. 6).

Thereafter, the display control process CP determines whether the image scanning operation is completed by checking the input-completion flag (S113 of FIG. 6). If the image scanning operation is not completed (S113 of FIG. 6: NO), the display control process CP waits at step S113 until the image scanning operation is completed. When the image scanning operation is completed (S113 of FIG. 6: YES), the display control process CP enlarges the “printing” object in the display 2 (S114 of FIG. 6).

Thereafter, the display control process CP determines whether the image forming operation is completed (S115 of FIG. 6). When the printout (image formation) of all the images scanned from the sheets (documents) is completed, the print output process step OP3 sends a notice that the image forming operation is completed to the display control process CP through the monitoring process MP, and, accordingly, a determination is made based on the notice that the image forming operation is completed.

The display control process CP is permitted to determine the completion of the image forming operation based on the flag or from the value of the counter by allowing the print output process step OP3 to reset the flag or the counter that shows progress.

When the notice that the image forming operation is completed is received (S115 of FIG. 6: YES), the display control process CP enlarges the “copy complete” object in the display 2 (S116 of FIG. 6), and the copy mode process is completed.

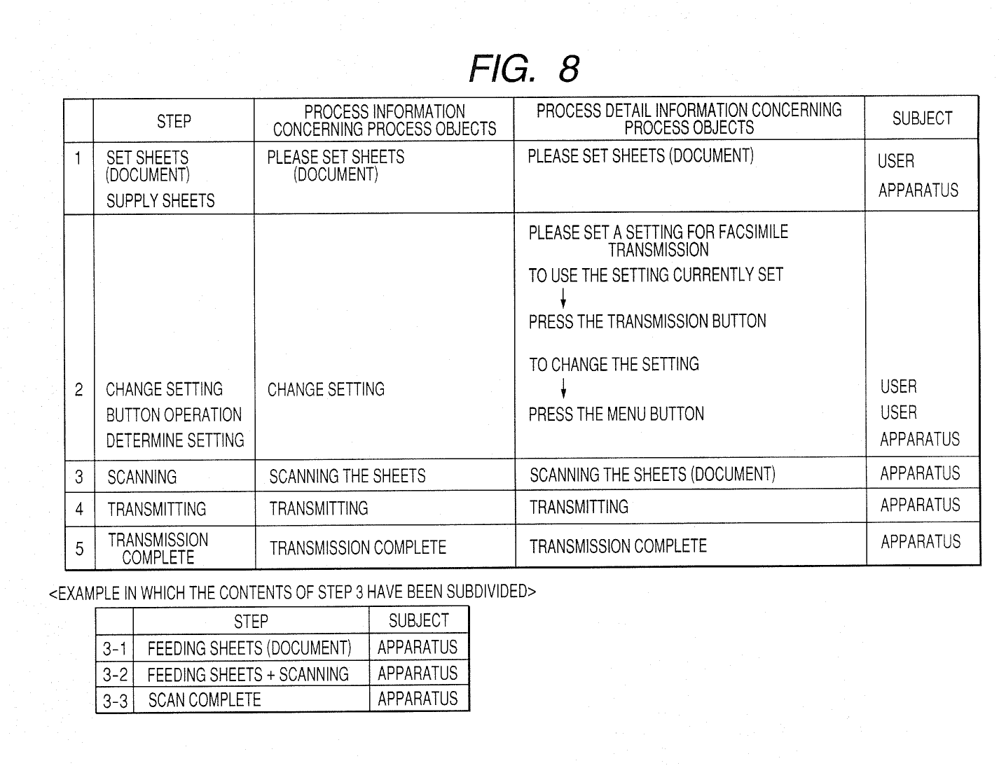

FIG. 8 is a table showing display data to be displayed in a fax transmission mode. The display data for the fax transmission mode has a plurality of records, each of which indicating a process, process information concerning a process object, process detail information concerning the details of the process object, and a subject (i.e., a user or an apparatus). The records are stored in order to be performed. In addition, in the display data for the fax transmission mode shown in FIG. 8, the third step (step 3) is subdivided into three steps, i.e., step 3-1, step 3-2, and step 3-3, and stored.

In the same way as the display data in the copy mode described above, the display data in the fax transmission mode are displayed in the display 2. In more detail, based on the display data in the fax transmission mode shown in FIG. 8, the display 2 displays a series of process objects including a “set sheets” object, a “change setting” object, a “scanning” object, a “transmitting” object, and a “transmission complete” object.

When the “change setting” object is activated, the CPU 27 controls the display 2 to enlarge the “change setting” object to display the enlarged message box showing process detail information to notify the user that “Please set a setting for facsimile transmission. To use the setting currently set ->Press the transmission button. To change the setting ->Press the menu button”.

In addition, since the third step (step 3) is subdivided into three steps (i.e., step 3-1, step 3-2, and step 3-3) in the display data in the fax transmission mode shown in FIG. 8, the “scanning” object can be subdivided into three process objects, i.e., an “feeding sheets” object, an “feeding sheets+scanning” object, and a “scan complete” object, so as to display these three process objects at appropriate timings.

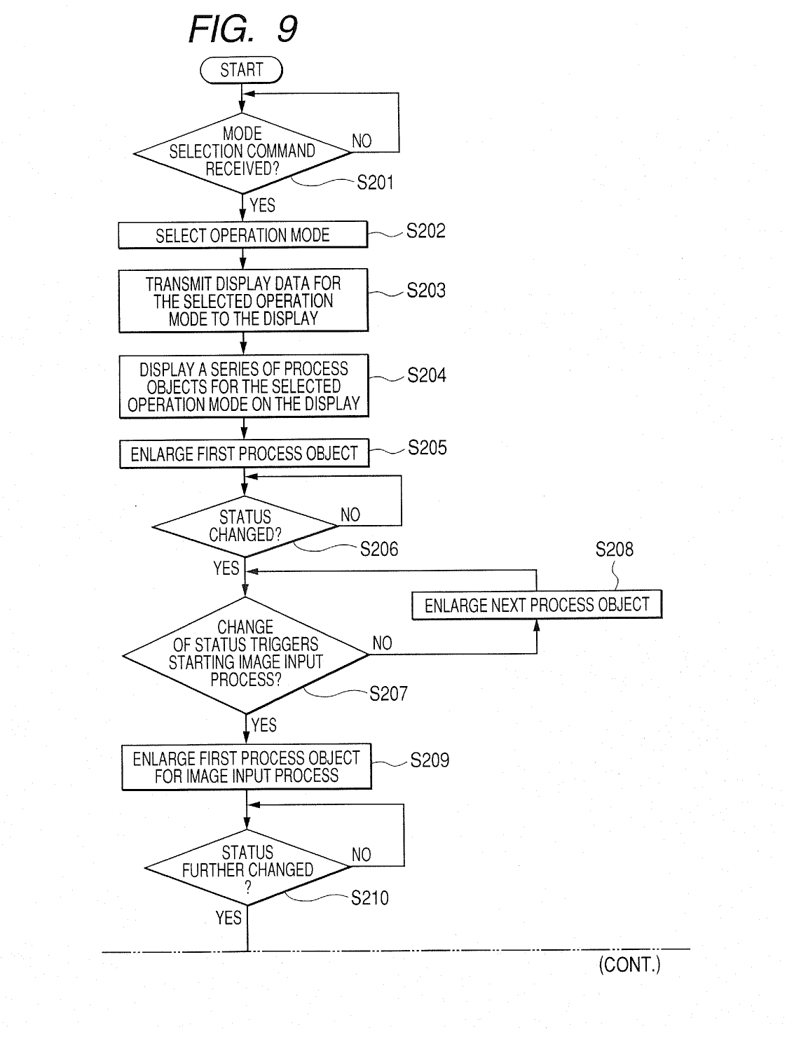

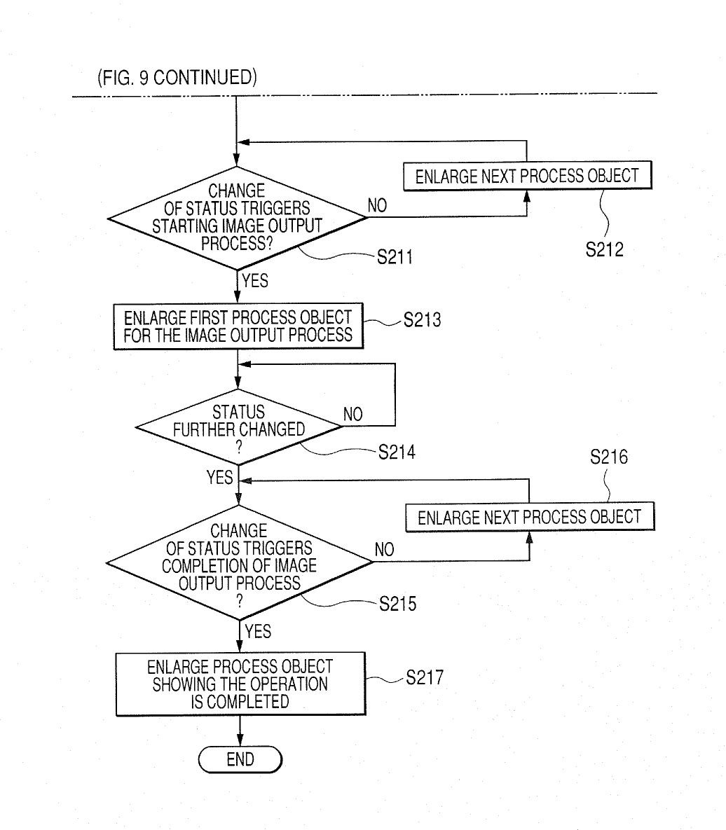

FIG. 9 is a flowchart showing a generalized operation mode process performed by the CPU 27 in accordance with the display control program 29a. The generalized operation mode process will be described with reference to FIG. 9.

When the display control process CP receives an mode selection command (S201 of FIG. 9: YES), CPU 27 selects an operation mode corresponding to the received mode selection command (S202 of FIG. 9).

Thereafter, the display control process CP acquires display data corresponding to the selected operation mode from the storage device 24, and transmits the acquired display data to the display 2 (S203 of FIG. 9).

As a result, the display 2 displays a plurality of steps to be performed in sequence in the selected operation mode in the form of a series of process objects (S204 of FIG. 9).

Thereafter, the display control process CP selects and enlarges a first process object from among the series of process objects (S205 of FIG. 9).

Thereafter, the display control process CP determines whether a status is changed or not (S206 of FIG. 9). If the status is not changed (S206 of FIG. 9: NO), the display control process CP waits at step S206.

If the status is changed (S206 of FIG. 9: YES), the display control process CP determines whether the change of the status triggers to start the image input process IP (S207 of FIG. 9).

If the change of the status does not trigger starting the image input process IP (S207 of FIG. 9: NO), the display control process CP enlarges the next process object (S208 of FIG. 9), and returns to step S207.

If the change of the status triggers starting the image input process IP (S207 of FIG. 9: YES), the display control process CP enlarges the first process object of the image input process IP (S209 of FIG. 9).

Thereafter, the display control process CP determines whether the status is further changed or not (S210 of FIG. 9).

If the status is not further changed (S210 of FIG. 9: NO), the display control process CP waits at step S210.

If the status is further changed (S210 of FIG. 9: YES), the display control process CP determines whether the change of the status triggers starting the image output process OP (S211 of FIG. 9). If the change of the status does not trigger starting the image output process OP (S211 of FIG. 9: NO), the display control process CP enlarges the next process object (S212 of FIG. 9), and returns to step S211.

If the change of the status triggers starting the image output process OP (S211 of FIG. 9:YES), the display control process CP enlarges the first process object of the image output process OP (S213 of FIG. 9).

Thereafter, the display control process CP determines whether the status if further changed or not (S214 of FIG. 9). If the status is not further changed (S214 of FIG. 9: NO), the display control process CP waits at step S214.

If the status is further changed (S214 of FIG. 9: YES), the display control process CP determines whether the change of the status triggers completion of the image output process OP (S215 of FIG. 9). If the change of the status does not trigger completion of the image output process OP (S215 of FIG. 9: NO), the display control process CP enlarges the next process object (S216 of FIG. 9), and returns to step S215.

If the change of the status triggers completion of the image output process OP (S215 of FIG. 9: YES), the display control process CP enlarges the last process object showing the completion of the operation (S217 of FIG. 9), and completes the generalized operation mode process.

According to the present example, a plurality of process steps through which functions are performed are displayed in the form of a series of process objects arranged in an order corresponding to an order in which the process steps are performed, and the active process object (i.e., the process step being performed), which is one of the series of process objects, is displayed to be enlarged. Therefore, the active process object can be displayed in an appearance different from that of the other process objects.

In the present example described above, the enlarged display form is used as a method for displaying the active process object in an appearance different from those of the other process objects. Instead, other methods may be employed, such as displaying the active process object by using a color different from those of other process objects or by highlighting a frame surrounding the active process object.

In the present example described above, the display 2 and the group of operation buttons 4 are formed as separate members. Instead, other configuration can be employed.

For example, an image of the operation panel 9 may be displayed on the display 2 so as to serve as an on-screen help, while displaying a plurality of process objects that shows a series of process steps required for performing the selected function above the image of the operation panel 9. And, the process objects may be selectively displayed to be active in accordance with the progress of the selected process.

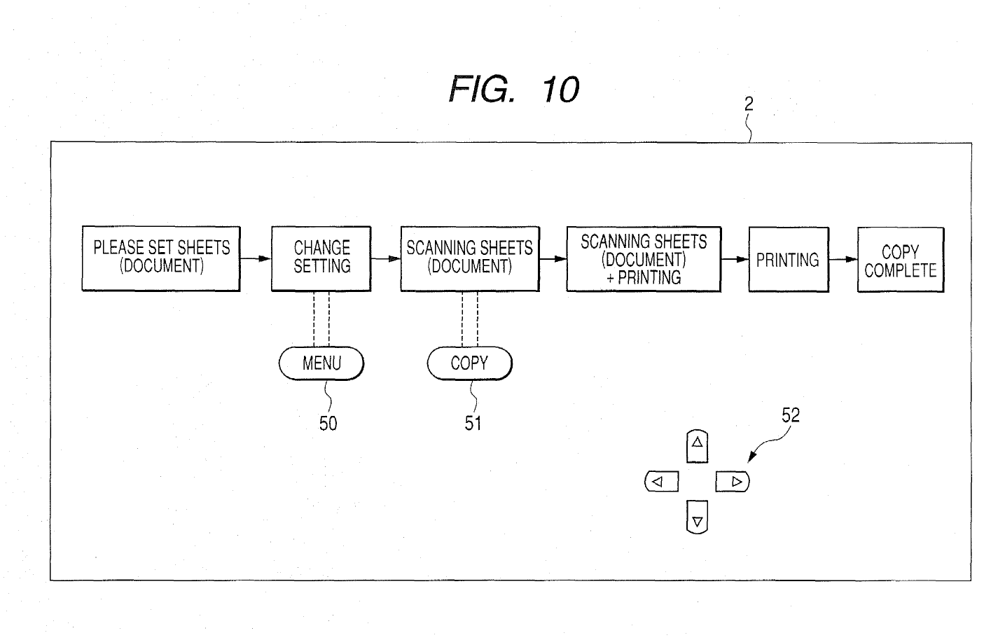

The display 2 may be provided with a touch panel device that allows the user to input operations by touching the screen of the display 2. An example of the screen displayed on the display 2 having the touch panel device is shown in FIGS. 10 and 11. As shown in FIG. 10, the display 2 may display the process objects arranged in an order corresponding to an order in which the process steps, which are required in performing the selected process (such as the process for providing the copy function), are performed. In the example shown in FIG. 10, images of buttons (referred to as button images) 50 and 51 are displayed in the screen where the process objects are displayed, the button images 50 and 51 representing buttons that the player should press in accordance with the progress of the selected process. Note that arrow button images 52 for allowing the user to input various selections are also displayed in the example shown in FIG. 10.

According to the example shown in FIG. 10, the user can intuitively understand what process step will be performed next when the button images 50 and 51 are pressed. When displaying the enlarged message box, the button images 50 and 51 may be displayed at positions away from the position where the enlarged message box is displayed, as shown in FIG. 11.

It is to be understood that the above-described example is merely an example of the present invention and, as a matter of course, the example can be appropriately changed without departing from the spirit and scope of the present invention.

What is claimed is:

1. An image processing apparatus comprising:
a display device; and
a processor that operates to:
perform a process for processing an image, the process including a plurality of process steps including an image acquiring process step for acquiring an image data and an image processing process step for processing the image data;
control the display device to display a plurality of process objects, each of which representing each of the process steps, to be arranged in an order corresponding to an order in which the process steps are performed; and
control the display device to display an active process object, which represents an active process step that is currently being performed, in an appearance different from that of other process objects that are currently being not performed.

2. The image processing apparatus according to claim 1, wherein the processor controls the display device to display process detail information representing detail of the active process step at a position near to a position where the active process object is displayed.

3. The image processing apparatus according to claim 2, wherein the processor controls the display device to display the process detail information at a position next to the position where the active process object is displayed.

4. The image processing apparatus according to claim 2, wherein the processor controls the display device to display the process detail information at a position where overlaps the active process object.

5. The image processing apparatus according to claim 2, wherein the processor controls the display device to display the process detail information in a message box displayed to be enlarged from the active process object.

6. The image processing apparatus according to claim 1, further comprising an operation unit that allows a user to input operations for selecting the process to be performed from among a plurality of processes that are performable by the processor,
wherein the processor performs the process selected by the user through the operation unit and controls the display device to display the process objects that represent the process steps included in the selected process.

7. The image processing apparatus according to claim 1, wherein the processor is operable to perform the process for providing at least one of:
a copy function for copying the image formed on a sheet to a recording sheet;
a facsimile function for transmitting and receiving the image;
a printer function for printing out the image on the recording sheet;
a scanner function for scanning the image formed on the sheet; and
an portable-device access function for accessing a portable device that is attachable to the image processing apparatus.

8. The image processing apparatus according to claim 1, further comprising an image forming unit that forms the image on a recording sheet,
wherein the processor performs the process including an image formation process step for controlling the image forming unit to form the image on the recording sheet.

9. The image processing apparatus according to claim 1, further comprising a scanner unit that scans the image formed on a sheet,
wherein the processor performs the process including an image scanning process step for controlling the scanner unit to scan the image formed on the sheet.

10. The image processing apparatus according to claim 1, further comprising a facsimile communication unit that transmits and receives the image through a facsimile communication,
wherein the processor performs the process including a facsimile communication process step for controlling the facsimile communication unit to transmit or receive the image.

11. An image processing apparatus comprising:
a display means for displaying information;
a processing means for performing a process for processing an image, the process including a plurality of process steps including an image acquiring process step for acquiring an image data and an image processing process step for processing the image data;
a first controlling means for controlling the display means to display a plurality of process objects, each of which representing each of the process steps, to be arranged in an order corresponding to an order in which the process steps are performed; and
a second controlling means for controlling the display means to display an active process object, which represents an active process step that is currently being performed, in an appearance different from that of other process objects that are currently being not performed.
